(19) United States
(12) Patent Application Publication
(10) Pub. No.: US 2025/0014077 A1
(43) Pub. Date: Jan. 9, 2025

(54) INCREMENTAL REACH PLANNER

(71) Applicant: ROKU, INC., SAN JOSE, CA (US)

(72) Inventors: MITHAL KOTHARI, SAN JOSE, CA (US); RICARDO VASQUEZ-SIERRA, SAN JOSE, CA (US); VINAY SHETTY, SANTA CLARA, CA (US); SCOTT HUANG, NEW YORK, NY (US); THOMAS MUSSER, SOMERVILLE, MA (US); CAIYI CHEN, FREMONT, CA (US); BHASKAR PARVATHANENI, CUPERTINO, CA (US)

(21) Appl. No.: 18/218,786

(22) Filed: Jul. 6, 2023

(51) Int. Cl. G06Q 30/0272; G06Q 30/0273; H04N 21/262

(52) U.S. Cl. CPC G06Q 30/0272; G06Q 30/0275; H04N 21/26241

(57) ABSTRACT

Disclosed herein are system, apparatus, article of manufacture, method and/or computer program product aspects, and/or combinations and sub-combinations thereof, for simulating the distribution of media content for ad-hoc procurements of supplemental media content. An example embodiment operates by determining what bid responses for available time-slots on multimedia networks would likely result in supplemental media content being shown to households, and to what extent under these simulations the supplemental media content is likely to be distributed to households.

### FIELD

This disclosure is generally directed to multimedia systems, and more particularly to the distribution of media content to a correct target audience.

### SUMMARY

Provided herein are system, apparatus, article of manufacture, method, and/or computer program product aspects, and/or combinations and sub-combinations thereof, for simulating the distribution of supplemental media content for ad-hoc procurements. The system, apparatus, article of manufacture, method, and/or computer program product aspects herein are designed to simulate scenarios where bid responses are made by a demand-side platform (DSP) on behalf of third-parties. The simulated scenarios can determine what bid responses would likely result in supplemental media content being shown to households, and to what extent the supplemental media content is likely to be distributed to a household. No conventional system, apparatus, article of manufacture, method, and/or computer program product aspects is known to be implemented to provide such insights.

In aspects, a DSP can implement and perform the operations described herein. Aspects operate by selecting, by at least one processor of a computing system, a sample of historic content data for a number of households (e.g., as determined by a cross device household graph), by randomly sampling the historic content data, where the historic content data includes bid requests for available time slots in a multimedia network, bid responses made in response to one or more of the bid requests for outputting supplemental media content in the available time slots, and an indication for each of the bid responses whether the respective bid response was won. Aspects further operate by selecting a sample of bid response data from the historic content data by randomly sampling the historic content data, where the bid response data includes one or more of the bid responses together with an indication for each bid response of the one or more bid responses whether the respective bid response was won. Aspects further operate by determining an estimated win rate by dividing a number of the bid responses won in the sample of bid response data by a total number of the bid responses in the sample of the bid response data. Aspects further operate by performing, for each bid request of each household of the number of households in the sample from the historic content data, a Monte Carlo simulation using the estimated win rate, thereby outputting a corresponding prediction whether the respective bid request would be won. Aspects further operate by generating, for each prediction output by the Monte Carlo simulation indicating a respective bid request would be won, a simulated impression of the supplemental media content. Aspects further operate by aggregating each simulated impression into a group of simulated impressions. Aspects further operate by performing a reach simulation using the group of simulated impressions to determine a reach for distributing the supplemental media content.

In aspects, the reach simulation is performed using the group of simulated impressions and one or more simulation inputs. The simulation inputs refer to parameters or variables that enable the reach simulation to perform its functions. In aspects, the simulation inputs can include at least: private market place deal identifiers (IDs), a total budget, a duration of a campaign, targeting criteria, and frequency caps. Based on the total budget, a daily budget for the reach simulation can be determined. Additionally, in aspects, simulated impressions can be isolated that fulfill the targeting criteria so that the reach simulation can be performed on those simulated impressions. For each simulated impression in the group of simulated impressions, the reach simulation can determine whether: (a) there are any available days to perform another iteration of the reach simulation such that the reach simulation is active. If determined that the reach simulation is active, for an available day of the reach simulation, (b) determining whether the simulated impression is available to be shown to a household. If determined that the simulated impression is available to be shown to the household, (c) determining whether there is an available daily budget for the available day to simulate a bid response for the simulated impression. If determined that there is an available daily budget to simulate the bid response for the simulated impression, (d) determining, for the household, whether the simulated impression is frequency capped for the household for the available day. If determined that the simulated impression of the supplemental media content is frequency capped for the household, (b)-(d) can be performed for a further simulated impression in the group of simulated impressions. If determined that the simulated impression is not frequency capped for the household, an amount from the daily budget can be subtracted to simulate an acquisition of the simulated impression for the household. The simulated impression can be stored for output to a graphical user interface (GUI), and (b)-(d) can be performed for a further simulated impression in the group of simulated impressions.

In aspects, if determined that the reach simulation has no available days such that it is not active, the output can be generated, where the output includes: stored simulated impressions, simulated household reach data, and simulated daily budget spend data. In aspects, an estimated reach can be determined based on combining the output with historical reach data, and outputting the combined output to a graphical user interface (GUI) for display. In aspects, if determined that the simulated impression is not available to be shown to the users, (a)-(d) can be performed for a next available day of the reach simulation. In aspects, if determined that there is not enough daily budget to simulate the bid response for the simulated impression: the daily budget remaining can be estimated for the reach simulation, and (a)-(d) can be performed for a next available day for the reach simulation. In aspects, (a)-(d) can be performed for one or more percentages of the daily budget. The reach simulation based on the one or more percentages will indicate how changes in the daily budget will affect household reach for the placement of the supplemental media content.

### BRIEF DESCRIPTION OF THE FIGURES

The accompanying drawings are incorporated herein and form a part of the specification.

FIG. 1 illustrates a block diagram of a multimedia environment, according to some aspects.

FIG. 2 illustrates a block diagram of a streaming media device, according to some aspects.

FIG. 3 illustrates a flow diagram of how simulated impressions can be generated, according to some aspects.

FIG. 4 illustrates a flow diagram of how a reach simulation for distributing supplemental media content is performed, according to some aspects.

FIG. 5 illustrates a method of performing the flow diagram of FIG. 3, according to some aspects.

FIG. 6 illustrates a method of performing the flow diagram of FIG. 4, according to some aspects.

FIG. 7 illustrates an example computer system useful for implementing various aspects.

In the drawings, like reference numbers generally indicate identical or similar elements. Additionally, generally, the left-most digit(s) of a reference number identifies the drawing in which the reference number first appears.

### DETAILED DESCRIPTION

A multimedia network (referred to herein as a television network or streaming network) may offer two forms of offering tip time-slots in their multimedia programming to third-parties interested in displaying their supplemental media content in those time slots. The supplemental media content can be an advertisement, infomercial, video, image, infographic, etc. to be displayed to household users.

The first form of offering up time slots is an upfront procurement (also referred to as programmatic direct). In an upfront procurement, a multimedia network offers up time slots in their multimedia programming. Third-parties can acquire an offered up time-slot at a fixed cost (e.g., a fixed cost per thousand impressions (CPM)) and at a pre-determined time. Upfront procurements are often advantageous because they allow third-parties to more closely target their supplemental media content to their desired target audience/demographic. This is because the third-parties know in advance what programming is scheduled at a particular time-slot, and can determine whether that programming is aligned to the target audience/demographic that their supplemental media content is directed towards.

The second form of offering tip time slots is an ad-hoc procurement (also referred to as real-time bidding). In an ad-hoc procurement, third-parties bid to acquire time-slots on an ad-hoc basis and in real-time. Real-time refers to the time at which the multimedia network programming is streaming on the multimedia network. Typically, how this process works is that a multimedia network reserves a portion of its time-slots for bidding. A Supply Side Platform (SSP) integrates with the multimedia network and sends bid requests to ad exchanges for the ad-hoc time-slots that are then consumed by demand-side platforms (DSPs) for bid consideration. The DSPs submit bid responses on behalf of third-parties to acquire these reserved time-slots to the SSP. An auction process is conduced by the SSP based on the bid responses, and the SSP notifies the DSP of winning bid responses. The third-parties with winning bid responses can then have their associated supplemental media content output on the multimedia network in the ad-hoc time slot they submitted their winning bid for.

A technological problem with ad-hoc procurements, however, is that the third-parties do not know in advance what audience/demographic their supplemental media content will reach Thus, third-parties are often unable to distribute supplemental media content to the correct target audience/demographic. Thus, technological systems and methods are needed to allow third-parties to better forecast the target audience/demographic they can reach through an ad-hoc procurement. Systems and methods are also needed to better assist in distributing supplemental media to the correct target audience/demographic when participating in an ad-hoc procurement.

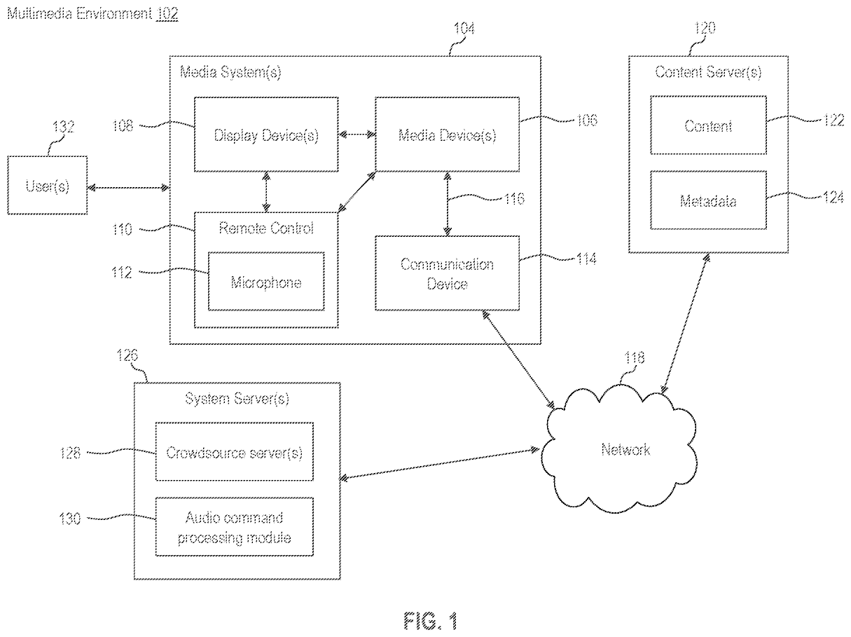

Provided herein are system, apparatus, device, method and/or computer program product aspects, and/or combinations and sub-combinations thereof, for simulating the distribution of media content based on bid responses for ad-hoc procurements. Various aspects of this disclosure may be implemented using and/or may be part of a multimedia environment 102 shown in FIG. 1. It is noted, however, that multimedia environment 102 is provided solely for illustrative purposes, and is not limiting. Aspects of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some aspects. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some aspects, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various aspects, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an aspect, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Throughout this disclosure the supplemental media content described/discussed is equivalent to the content 122.

In some aspects, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing aspects and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some aspects, the media device 106 may be audio responsive, and the audio data may represent verbal commands from the user 132 to control the media device 106 as well as other components in the media system 104, such as the display device 108.

In some aspects, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

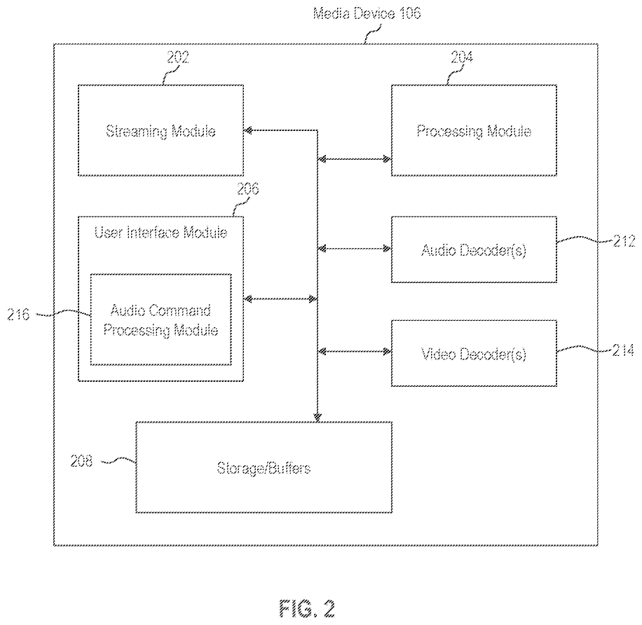

In some aspects, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some aspects. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to 11.263, 11.264, HEV, MPEG1, MPFG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some aspects, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming aspects, the streaming module 202 may transmit the content to the display device 108 in real time or near real time as it receives such content from the content server(s) 120. In non-streaming aspects, the media device 106 may store the content received from content server(s) 120 in storage/buffers 208 for later playback on display device 108.

### Generating Simulated Impressions

With respect to FIG. 1, one or more computing devices of the content servers 120 of FIG. 1, the system servers 126 of FIG. 1, or a combination thereof may be used to perform simulations for distribution of supplemental media content for ad-hoc procurements. The simulations, however, first require the generation of simulated impressions. The one or more computing devices of the content servers 120, the system servers 126, or a combination thereof may be used to generate the simulated impressions.

The simulations provide a technical advantage because they help in improving the functioning of computers and computer networks and/or multimedia networks. By determining the potential reach for the supplemental media content, the simulations can indicate how best to allocate resources to distribute data over networks to achieve the maximum reach for the supplemental media content. The simulations also save computing resources because, by knowing how to distribute data over networks to achieve the maximum reach, resources are not wasted, network traffic is optimized, and overall data flow is improved over the networks. The simulations also provide a technical advantage because they save compute resources (processing and storage) because of how historic data used in the simulations is sampled. The sampling allows the simulations to only analyze a subset of historic data and not an entire data set. By analyzing a subset of data, the order of magnitude of the data needed to be processed can be reduced by over 100 times, and thus less data needs to be stored and processed when performing the simulations, thus increasing performance and generating simulation results in a timely and fast manner than if a larger set of data were to be processed.

While discussed in this disclosure with respect to supplemental media content, this system can also be applied in other contexts, such as distributing packets of data, documents, messages, or other forms of data over networks. Thus, a person of ordinary skill in the art will recognize, reading this disclosure, how to apply the disclosure in other contexts.

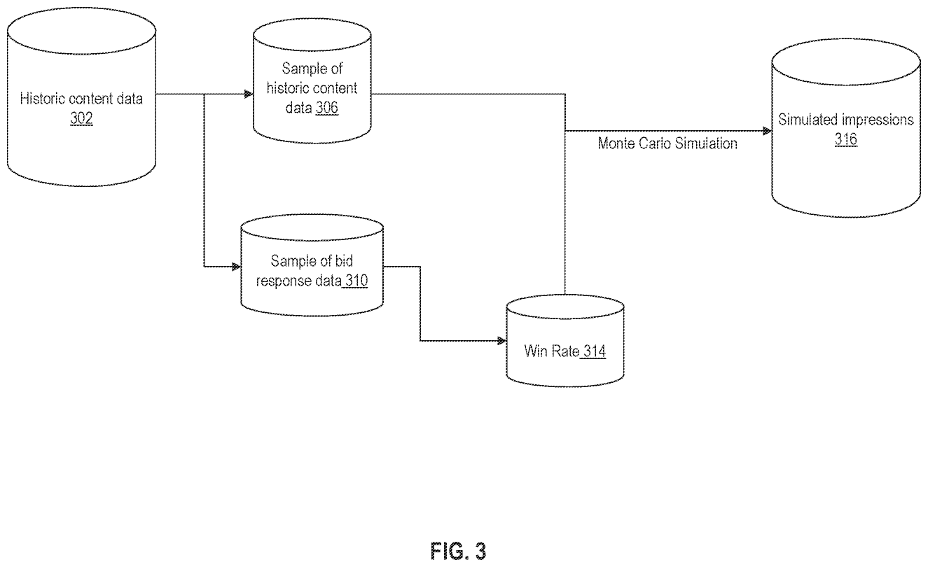

FIG. 3 illustrates a flow diagram 300 of how simulated impressions 316 can be generated, according to some aspects. Simulated impressions 316 refer to simulated impressions of the supplemental media content. The simulated impressions 316 can represent whether the bid responses made by third-parties to show their supplemental media content on multimedia networks would have been won (e.g., would have been displayed on the multimedia networks had the bid responses been made).

In aspects, once generated, the simulated impressions 316 can be aggregated and used in a reach simulation. The reach simulation can determine a potential reach of the supplemental media content had the bid response been won. I-ow the reach simulation is performed will be described further below. The reach simulation can represent a simulated campaign for a third-party. The reach simulation can allow third-parties to determine a potential reach for their supplemental media content (e.g., how many and what households their supplemental media content could potentially reach) if they placed certain bid responses to show the supplemental media content on a multimedia network. These projections allow for insights that could not be obtained previously. These insights are also useful for predicting the success of future campaigns and potential reach of the supplemental media content based on future bid responses made by or on behalf of third-parties. Thus, flow diagram 300 is a data preparation procedure that allows for the reach simulation to take place.

In aspects, flow diagram 300 can be performed by one or more computing devices of the content servers 120 of FIG. 1, the system servers 126 of FIG. 1, or a combination thereof. In aspects, flow diagram 300 can begin by having one or more computing devices of the content servers 120, the system servers 126, or a combination thereof perform two data aggregations. The first data aggregation can aggregate sampled historic content data 302 to generate a sample of historic content data 306.

The historic content data 302 refers to data related to the bidding process for supplemental media content between the multimedia networks, the SSPs, and third-parties (e.g., DSPs). In aspects, historic content data 302 includes information regarding bid requests for available time slots in a multimedia network, bid responses made in response to one or more of the bid requests for outputting supplemental media content in the available time slots, and an indication for each of the bid responses whether the respective bid response was won. In aspects, the historic content data 302 can also include other data such as the time slots that are bid on, what programming the time slots relate to, what supplemental media content a bid response was placed for, etc. The sample of historic content data 306 can be obtained by sampling the historic content data 302 for a number of household.

In aspects, the second data aggregation can aggregate sampled historic content data 302 to generate a sample of bid response data 310. The sample of bid response data 310 refers to bid response data with an indication that the bid responses made were won. In aspects, the historic content data 302 sampled for the second data aggregation can be different or overlap with that of the first data aggregation. Thus, in aspects, two independent yet potentially overlapping data sets are obtained.

In aspects, once the data aggregations occur, flow diagram 300 can proceed by determining a win rate 314 for the bid responses made. The win rate 314 refers to a historic win rate for bid responses made by third-parties, where bid responses that were won resulted in impressions of the supplemental media content being shown to households (e.g., user(s) 132 of FIG. 1). In aspects, the win rate 314 can be determined by dividing a number of the bid responses won in the sample of bid response data 310 by a total number of the bid responses in the sample of the bid response data 310. In other aspects, the win rate 314 can be predicted based on the historic content data 302. For example, machine learning models can be trained to predict a win rate 314 using the historic content data 302. The machine learning models can be non-sequential models that can predict the win rate 314 based on past behavior and historic patterns in win rates.

In aspects, the win rate 314 can be generated in the form of a percentage. For example, the win rate 314 can be expressed as 10%, 20%, etc. or as a decimal number such as 0.10, 0.20, etc. In aspects, the win rate 314 can be expressed at a certain cadence, for example, the win rate 314 can be determined per day, week, month, etc. The discretion of what cadence the win rate 314 is determined by a designer/architect of the system.

In aspects, once the win rate 314 is determined, the simulated impressions 316 can be generated using the win rate 314 as applied to the bid requests of the sample of historic content data 306. In aspects, in order to generate the simulated impressions 316, a Monte Carlo simulation can be performed on the sample of historic content data 306 taking into consideration the win rate 314 and a total number of bid requests made for the sample of historic content data 306. Monte Carlo simulations are known to persons of skill in the art so the details of the Monte Carlo simulation will not be described in detail. In aspects, based on the output of the Monte Carlo simulation, a simulated impression representing the supplemental media content can be generated. In aspects, the output of the Monte Carlo simulation can be a binary decision predicting whether a bid response to a bid request of each household of the number of households in the sample of historic content data 306 would be won if placed. If the simulated impression is generated it represents that had the bid response been placed for that bid request, it would have been won and a simulated impression of the supplemental media content would have been shown to users.

In other aspects, other models can be used. For example, machine learning models can be used to generate simulated impressions 316. For example, machine learning models can be used to predict that had the bid response been placed, it would have been won and shown to users. The machine learning models can do this by being trained to recognize patterns of factors that resulted in historic wins using the sample of historic content data 306 and/or the win rate 314. The factors can include, but are not limited to, for what time-slots the bid responses were placed, for what content the bid responses were placed, the amount for the bid responses, and other relevant information contained in the historic content data 302.

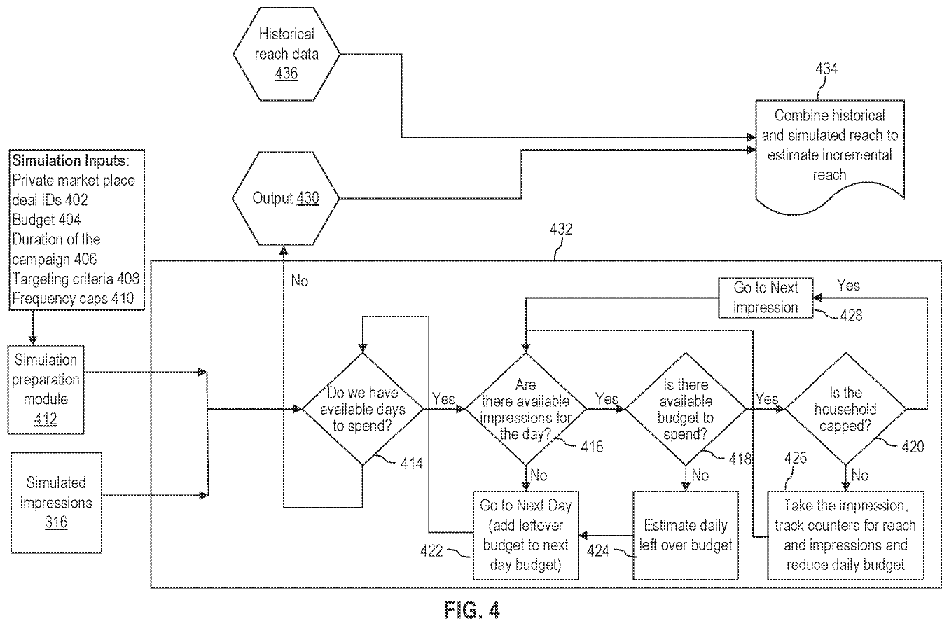

In aspects, this process for generating simulated impressions 316 can be performed for all bid request data in the sample of historic content data 306. Once performed, the aggregate of instances of simulated impressions 316 generated can form the simulated impressions 316. In aspects, the simulated impressions 316 can then be transmitted to a software application to be used in a reach simulation as previously indicated, and as will be described with respect to FIG. 4.

### The Simulation

FIG. 4 illustrates a flow diagram 400 of how a reach simulation 432 for distributing supplemental media content is performed, according to some aspects. In aspects, the flow diagram 400 and the reach simulation 432 can be performed by one or more computing devices of the content servers 120 of FIG. 1, the system servers 126 of FIG. 1, or a combination thereof. In aspects, flow diagram 400 can begin by having one or more simulation inputs be input into a simulation preparation module 412. The simulation inputs refer to parameters or variables that are needed for the reach simulation 432 to perform its functions. In aspects, the simulation inputs can include at least: private market place deal IDs 402, a budget 404, a duration of a campaign 406, targeting criteria 408, and frequency caps 410.

The private marketplace deal IDs 402 refer to identification numbers that refer to historic opportunities to place bid responses on behalf of third-parties to acquire ad-hoc time-slots. These private marketplace deal IDs 402 are provided by the SSPs. Because the SSPs have to identify opportunities that are available for bid responses, they can identify the opportunities to the third-parties through the private marketplace deal IDs 402.

The budget 404 refers to how much third-parties have to spend on bid responses for the duration of their campaign. The budget 404 can be in the form of a monetary value. This can include flat currency, digital currency, credits, etc.

The duration of the campaign 406 refers to the duration of the campaign for making bid responses. This can be expressed in hours, days, weeks, months, etc.

The targeting criteria 408 refers to target audiences/demographics that the third-party wants to target with the supplemental media content. The target criteria 408 can be a series of filters, parameters, and/or variables that can indicate demographic information such as average household age, geographic region, income level, marital status, etc. that can be used to filter and further target the bid responses for time-slots related to multimedia network programming that meet the target audience/demographic. In this way, the targeting criteria 408 allows bid responses to be placed to better align the supplemental media content/simulated impressions with the intended target.

The frequency caps 410 refer to the amount of times that a third-party wants a particular household (e.g., user(s) 132 of FIG. 1) to be exposed to the campaign. For example, a third-party may want to limit the number of times a supplemental media content is shown to households. The frequency caps 410 can indicate a ceiling for the number of times the supplemental media content can be shown. The frequency caps 410 can be expressed in number of times a supplemental media content is shown per hour, day, week, month, etc.

In aspects, once the simulation inputs are entered into the simulation preparation module 412, the simulation preparation module 412 can determine a daily budget for the reach simulation 432. In aspects, the daily budget can take various forms. For example, the daily budget can be an even split of the budget 404 across the duration of the campaign 406. In other aspects, the daily budget can be set to be unequal during the duration of the campaign 406, such that it can vary by day. For example, if the campaign has a duration of X days, the campaign can be split in half (e.g., X/2). In aspects, the number of days in the first half of the campaign can have the daily budget be set to a higher multiple of those of the second half. In other aspects, the number of days in the second half of the campaign can have the daily budget set to a higher multiple of those of the first half. In other aspects, the daily budget can be set to increase by day or decrease by day. The aforementioned are merely examples, and a person of ordinary skill in the art reading this disclosure can determine other ways of setting the daily budget.

In aspects, once the simulation preparation module 412 determines the daily budget, control, the simulation inputs, the daily budget, and the simulated impressions 316 determined using flow diagram 300 of FIG. 3, can be input into the reach simulation 432. In aspects, the reach simulation 432 can be performed by a software application. The software application can be a standalone desktop application, an application installed on a server, or can be a distributed application installed on multiple servers and/or a cloud computing environment.

In aspects, the reach simulation 432 can perform a series of determinations in order to generate its output 430 indicating to what extent the supplemental content is likely to be distributed to households. In aspects, the reach simulation 432 can proceed in the following manner. For each simulated impression of the simulated impressions 316, the reach simulation 432 can, (a) determine whether the reach simulation 432 has any available days to perform the reach simulation 432 such that the reach simulation 432 is active. This determination is shown as 414 in FIG. 4. Thus, what is first determined is if the campaign is active and whether an iteration or another iteration of the reach simulation should be performed. In aspects, this can be done by evaluating whether the duration of the campaign 406 has a value greater than 0.

In aspects, if determined that the reach simulation 432 is active, then the reach simulation 432 can, (b) for an available day of the reach simulation 432, determine whether the simulated impression is available to be shown to households, as shown by 416 in FIG. 4. In aspects, this can depend on whether or not all the simulated impressions 316 have been exhausted/processed. If, for example, all the simulated impressions 316 have been processed by the reach simulation 432 such that there are no further simulated impressions 316 to evaluate and/or to place simulated bid responses on, then there would be no further simulated impressions 316 to show to households. If, however, there are further simulated impressions 316 to be processed by the reach simulation 432, there would be available simulated impressions 316 to show to households. It is assumed that for the first pass through the reach simulation 432, there are simulated impressions 316 to process. This may not be the case for subsequent passes by the reach simulation 432.

In aspects, and assuming that it is determined that there are available simulated impressions 316 to show to households, the reach simulation 432 can proceed to, (c) determine whether there is an available daily budget for the available day to simulate a bid response for the simulated impression, as shown by 418.

If it is determined that there is an available daily budget, the reach simulation 432 can proceed to, (d) determine for each household being considered to show the supplemental media content to, whether the simulated impression is frequency capped for the household for the available day, as shown by 420. In aspects, if determined that the simulated impression of the supplemental content is frequency capped for the household, the simulated impression can be bypassed and the reach simulation 432 can perform steps (b)-(d) for a further simulated impression in the group of simulated impressions 316, as shown by 428.

In aspects, if determined that the household is not frequency capped, the reach simulation 432 can further proceed, as shown by 426, by subtracting an amount from the daily budget to simulate an acquisition of the simulated impression for the household; storing the simulated impression for output to a graphical user interface (GUI); and performing (b)-(d) for a further simulated impression in the group of simulated impressions. The amount subtracted from the daily budget can be any value that is reasonably set to simulate a bid response that would typically be placed to show the simulated impression/supplemental media content. The reach simulation 432 can proceed pursuant to the above manner until one or more of the conditions assumed above does not apply. What happens when the one or more conditions assumed above does not apply will now be discussed.

In aspects, if it is determined that the reach simulation 432 has no available days such that it is not active, the reach simulation 432 can generate an output 430. In aspects, the output 430 can include the stored simulated impressions to be shown, simulated household reach data, and simulated daily budget spend data. In aspects, the output 430 can be displayed on a GUt. In aspects, the stored simulated impressions can be listed as a list or in table format listing which simulated impressions/supplemental media content is to be shown. In aspects, associated simulated household reach data can be shown for the reach simulation. The simulated household reach data can be displayed showing the projected reach of the simulated impressions 316 based on the targeting criteria 408. For example, for each of the private market place deal IDs 402 that were submitted on, and based on the targeting criteria 408, the reach simulation 432 can determine what time-slots the simulated impressions 316 were simulated to be shown on, what the demographics for that time-slot was, how many households were potentially watching the multimedia network programming at that time-slot, etc. In this way, simulated household reach data can be obtained and displayed. In aspects, simulated daily budget spend data can also be displayed. In aspects, the simulated daily budget can indicate how much of the daily budget was used in making bid responses, and can be broken down by how much of the daily budget was used for bid responses on particular simulated impressions 316.

In aspects, the output 430 can also be cross-referenced with historical reach data 436 to determine an estimated reach 434 that third-parties can attain if they spend budgets in the resulting simulation. The estimated reach 434 refers to a projection/extrapolation, taking into account historical inputs, such as the reach of historic campaigns.

In aspects, if it is determined that the simulated impression is not available to be shown to users, then the reach simulation 432 can perform steps (a)-(d) for a next available day of the simulation, as shown by 422.

In aspects, if it is determined that there is not enough daily budget to simulate the bid response for the simulated impression, the reach simulation 432 can proceed by, estimating the daily budget remaining for the reach simulation 432, and perform steps (a)-(d) for a next available day of the simulation, as shown by 424.

In aspects, the reach simulation 432 can perform steps (a)-(d) for one or more percentages of the daily budget. The one or more percentages refer to multiples of the daily budget. For example, in aspects, the reach simulation 432 can be performed for 1.1×, 1.2×, 1.3×, 1.4×, 1.5×, etc. of the daily budget. The aforementioned are example multiples and any multiple can be chosen by a designer of the system. In aspects, the multiples can also include reducing the daily budget, for example, performing the reach simulation 432 for 0.7×, 0.6×, 0.5×, etc. of the daily budget. Performing the reach simulation 432 for multiples of the daily budget can show/indicate how changes in the daily budget will affect the distribution of the supplemental media content, and how it changes household reach. In this way, insights can be obtained as to how to properly allocate resources for optimal distribution of the supplemental media content and help decide which supplemental media content generates the largest incremental reach the available budget.

It has been discovered that the reach simulation 432 and the methods of generating simulated impressions 316 provides several technical advantages. First, it helps in improving the functioning and performance of simulations on computers and computer networks and/or multimedia networks. The reach simulation can indicate how best to distribute large data sets over a multimedia network to determine optimal reach for supplemental media content in a fast and efficient manner. By knowing how to distribute data over the multimedia network to achieve maximum reach, resources are not wasted, multimedia network traffic is optimized, and overall data flow is improved over the multimedia network.

Second, it improves forecasting for potential future campaigns. Future distributions of the supplemental media content can be based on the output of the reach simulation. Third-parties can use the output to understand how to place bid responses according to scenarios where the reach simulation indicates those bid responses would have been won. Thus, by knowing how to distribute data over the multimedia network to achieve the maximum reach, third-parties do not waste resources (financial and computing) when placing bid responses.

Third, the reach simulation 432 also provides a technical advantage because it saves compute resources (e.g., processing time and storage) because of how it samples historic data. The sampling allows the simulation to only predict using a subset of historic content data 302 and not an entire data set. By analyzing a subset of the data, the order of magnitude of the data needed to be processed can be reduced by over 100 times, and thus less data needs to be stored and processed when performing the simulation.

### Methods of Operation

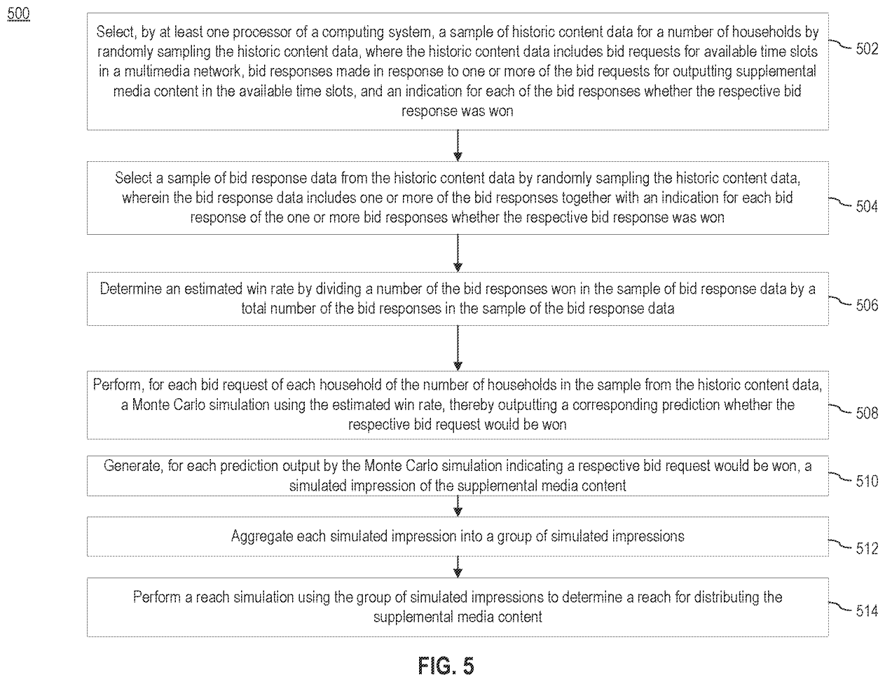

FIG. 5 is a flowchart for a method 500 of performing the flow diagram of FIG. 3, according to some aspects. Method 500 can be performed by one or more computing devices of the content servers 120 of FIG. 1, the system servers 126 of FIG. 1, or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to FIG. 5. However, method 500 is not limited to that example embodiment.

In step 502, a sample of historic content date 306 is selected for a number of households by randomly sampling the historic content data 302, where the historic content data 302 includes bid requests for available time slots in a multimedia network, bid responses made in response to one or more of the bid requests for outputting supplemental media content in the available time slots, and an indication for each of the bid responses whether the respective bid response was won.

In step 504, a sample of bid response data 310 can be selected from the historic content data 302 by randomly sampling the historic content data 302, wherein the bid response data includes one or more of the bid responses together with an indication for each bid response of the one or more bid responses whether the respective bid response was won.

In step 506, an estimated win rate 314 can be determined by dividing a number of the bid responses won in the sample of bid response data 310 by a total number of the bid responses in the sample of the bid response data 310.

In step 508, and for each bid request of each household of the number of households in the sample from the historic content data 306, a Monte Carlo simulation using the estimated win rate 314, thereby outputting a corresponding prediction whether the respective bid request would be won.

In step 510, for each prediction output by the Monte Carlo simulation indicating a respective bid request would be won, a simulated impression of the supplemental media content can be generated.

In step 512, each simulated impression can be aggregated into a group of simulated impressions 316.

In step 514, a reach simulation 432 can be performed using the group of simulated impressions 316 to determine a reach for distributing the supplemental media content.

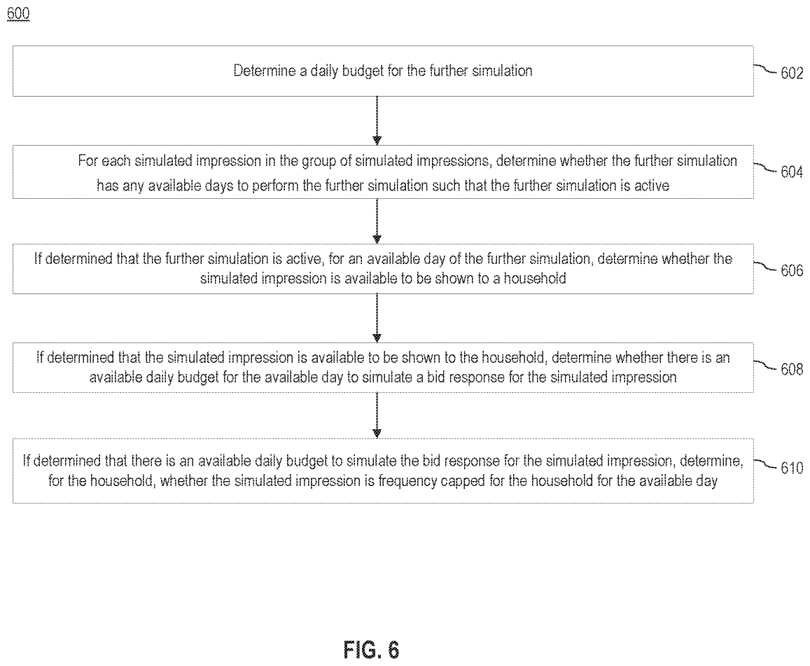

FIG. 6 is a flowchart for a method 600 of performing the flow diagram of FIG. 4, according to some aspects. Method 600 can be performed by one or more computing devices of the content servers 120 of FIG. 1, the system servers 126 of FIG. 1, or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art. Method 600 shall be described with reference to FIG. 6. However, method 600 is not limited to that example embodiment.

In step 602, a daily budget can be determined for the reach simulation 432.

In step 604, for each simulated impression in the group of simulated impressions 316, (a) a determination can be made whether the reach simulation 432 has any available days to perform the reach simulation 432, such that the reach simulation 432 is active.

In step 606, if determined that the reach simulation is active, (b) for an available day of the reach simulation 432, a determination can be made whether the simulated impression is available to be shown to a household.

In step 608, if determined that the simulated impression is available to be shown to the household, (c) a determination can be made whether there is an available daily budget for the available day to simulate a bid response for the simulated impression.

In step 610, if determined that there is an available daily budget to simulate the bid response for the simulated impression, (d) a determination can be made, for the household, whether the simulated impression is frequency capped for the household for the available day.

If determined that the simulated impression of the supplemental media content is frequency capped for the household, steps (b)-(d) can be performed for a further simulated impression in the group of simulated impressions 316. If determined that the simulated impression is not frequency capped for the household, an amount can be subtracted from the daily budget to simulate an acquisition of the simulated impression for the household. The simulated impression can be stored for later output to a graphical user interface (GUI), steps (b)-(d) can be performed for a further simulated impression in the group of simulated impressions 316.

### Architecture of Computer Systems Implementing the System

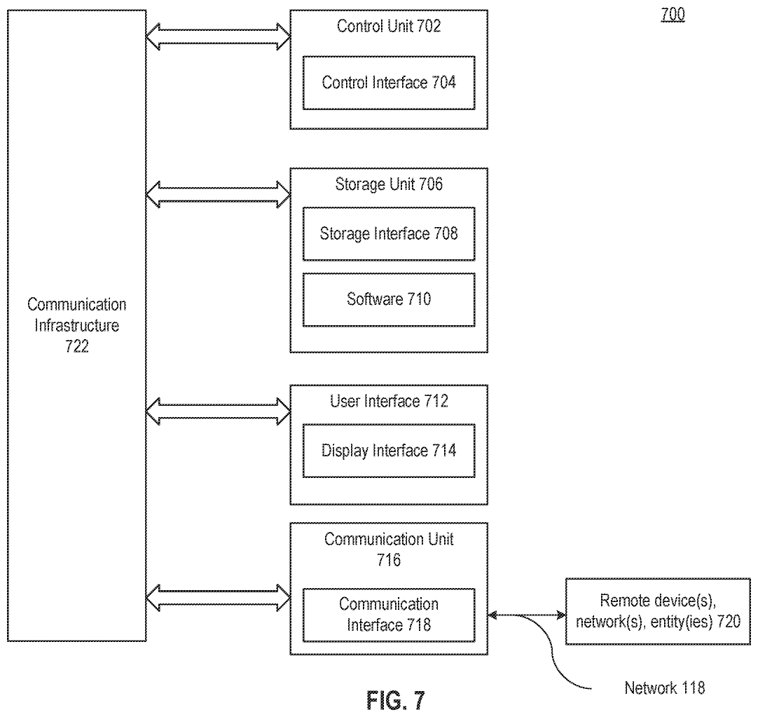

FIG. 7 illustrates an example computer system 700 useful for implementing various aspects. In aspects, the computer system 700 may be the components of the servers (e.g., content servers 120 or system servers 126) that can perform the functions described with respect to FIGS. 3-6. In aspects, the computer system 700 may include a control unit 702, a storage unit 706, a communication unit 716, and a user interface 712. The control unit 702 may include a control interface 704. The control unit 702 may execute a software 710 to provide some or all of the intelligence of computer system 700. The control unit 702 may be implemented in a number of different ways. For example, the control unit 702 may be a processor, an application specific integrated circuit (ASIC), an embedded processor, a microprocessor, a hardware control logic, a hardware finite state machine (FSM), a digital signal processor (DSP), a field programmable gate array (FPGA), a graphics processing unit (GPU), or a combination thereof.

The control interface 704 may be used for communication between the control unit 702 and other functional units or devices of computer system 700. The control interface 704 may also be used for communication that is external to the functional units or devices of computer system 700. The control interface 704 may receive information from the functional units or devices of computer system 700, or from remote devices 720 such as devices of the SSPs used in conjunction with the computer system 700, or may transmit information to the functional units or devices of computer system 700, or to remote devices 720. The remote devices 720 refer to units or devices external to computer system 700.

The control interface 704 may be implemented in different ways and may include different implementations depending on which functional units or devices of computer system 700 or remote devices 720 are being interfaced with the control unit 702. For example, the control interface 704 may be implemented with optical circuitry, waveguides, wireless circuitry, wireline circuitry to attach to a bus, an application programming interface, or a combination thereof. The control interface 704 may be connected to a communication infrastructure 722, such as a bus, to interface with the functional units or devices of computer system 700 or remote devices 720.

The storage unit 706 can be a non-transitory computer readable medium for storing instructions. The storage unit 706 may store the software 710. For illustrative purposes, the storage unit 706 is shown as a single element, although it is understood that the storage unit 706 may be a distribution of storage elements. Also for illustrative purposes, the storage unit 706 is shown as a single hierarchy storage system, although it is understood that the storage unit 706 may be in a different configuration. For example, the storage unit 706 may be formed with different storage technologies forming a memory hierarchical system including different levels of caching, main memory, rotating media, or off-line storage. The storage unit 706 may be a volatile memory, a nonvolatile memory, an internal memory, an external memory, or a combination thereof. For example, the storage unit 706 may be a nonvolatile storage such as nonvolatile random access memory (NVRAM), Flash memory, disk storage, or a volatile storage such as static random access memory (SRAM) or dynamic random access memory (DRAM).

The storage unit 706 may include a storage interface 708. The storage interface 708 may be used for communication between the storage unit 706 and other functional units or devices of computer system 700. The storage interface 708 may also be used for communication that is external to computer system 700. The storage interface 708 may receive information from the other functional units or devices of computer system 700 or from remote devices 720, or may transmit information to the other functional units or devices of computer system 700 or to remote devices 720. The storage interface 708 may include different implementations depending on which functional units or devices of computer system 700 or remote devices 720 are being interfaced with the storage unit 706. The storage interface 708 may be implemented with technologies and techniques similar to the implementation of the control interface 704.

The communication unit 716 may enable communication to devices, components, modules, or units of computer system 700 or to remote devices 720. For example, the communication unit 716 may permit the computer system 700 to communicate between its components such as the content servers 120 and the system servers 126. The communication unit 716 may further permit the devices of computer system 700 to communicate with remote devices 720 such as the SSPs, an attachment, a peripheral device, or a combination thereof through network 118.

As previously indicated with respect to FIG. 1, the network 118 may span and represent a variety of networks and network topologies. For example, the network 118 may be part of a network and include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 118. Cable, Ethernet, digital subscriber line (DSL), fiber optic lines, fiber to the home (FTTH), and plain old telephone service (POTS) are examples of wired communication that may be included in the network 118. Further, the network 118 may traverse a number of network topologies and distances. For example, the network 118 may include direct connection, personal area network (PAN), local area network (LAN), metropolitan area network (MAN), wide area network (WAN), or a combination thereof.

The communication unit 716 may also function as a communication hub allowing computer system 700 to function as part of the network 118 and not be limited to be an end point or terminal unit to the network 118. The communication unit 716 may include active and passive components, such as microelectronics or an antenna, for interaction with the network 118.

The communication unit 716 may include a communication interface 718. The communication interface 718 may be used for communication between the communication unit 716 and other functional units or devices of computer system 700 or to remote devices 720. The communication interface 718 may receive information from the other functional units or devices of computer system 700, or from remote devices 720, or may transmit information to the other functional units or devices of the computer system 700 or to remote devices 720. The communication interface 718 may include different implementations depending on which functional units or devices are being interfaced with the communication unit 716. The communication interface 718 may be implemented with technologies and techniques similar to the implementation of the control interface 704.

The user interface 712 may present information generated by computer system 700. The user interface 712 may interact with input devices and an output device. Examples of the input device of the user interface 712 may include a keypad, buttons, switches, touchpads, soft-keys, a keyboard, a mouse, or any combination thereof to provide data and communication inputs. Examples of the output device may include a display interface 714. The control unit 702 may operate the user interface 712 to present information generated by computer system 700. The control unit 702 may also execute the software 710 to present information generated by computer system 700, or to control other functional units of computer system 700. The display interface 714 may be any graphical user interface such as a display, a projector, a video screen, or any combination thereof.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, passive devices, or a combination thereof. Further, if a module or unit is written in the system or apparatus claims section below, the module or unit is deemed to include hardware circuitry for the purposes and the scope of the system or apparatus claims.

The modules and units in the aforementioned description of the aspects may be coupled to one another as described or as shown. The coupling may be direct or indirect, without or with intervening items between coupled modules or units. The coupling may be by physical contact or by communication between modules or units.

### CONCLUSION

The sections set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A computer-implemented method for distributing media content comprising:
selecting, by at least one processor of a computing system, a sample of historic content data for a number of households by randomly sampling the historic content data, where the historic content data includes bid requests for available time slots in a multimedia network, bid responses made in response to one or more of the bid requests for outputting supplemental media content in the available time slots, and an indication for each of the bid responses whether the respective bid response was won;
selecting a sample of bid response data from the historic content data by randomly sampling the historic content data, wherein the bid response data includes one or more of the bid responses together with an indication for each bid response of the one or more bid responses whether the respective bid response was won;
determining an estimated win rate by dividing a number of the bid responses won in the sample of bid response data by a total number of the bid responses in the sample of the bid response data;
performing, for each bid request of each household of the number of households in the sample from the historic content data, a Monte Carlo simulation using the estimated win rate, thereby outputting a corresponding prediction whether the respective bid request would be won:
generating, for each prediction output by the Monte Carlo simulation indicating a respective bid request would be won, a simulated impression of the supplemental media content;
aggregating each simulated impression into a group of simulated impressions; and
performing a reach simulation using the group of simulated impressions to determine a reach for distributing the supplemental media content.

2. The computer-implemented method of claim 1, further comprising:
determining a daily budget for the reach simulation; and
for each simulated impression in the group of simulated impressions,
(a) determining whether the reach simulation has any available days to perform the reach simulation such that the reach simulation is active,
(b) if determined that the reach simulation is active, for an available day of the reach simulation, determining whether the simulated impression is available to be shown to a household,
(c) if determined that the simulated impression is available to be shown to the household, determining whether there is an available daily budget for the available day to simulate a bid response for the simulated impression, and
(d) if determined that there is an available daily budget to simulate the bid response for the simulated impression, determining, for the household, whether the simulated impression is frequency capped for the household for the available day, and
if determined that the simulated impression of the supplemental media content is frequency capped for the household, performing (b)-(d) for a further simulated impression in the group of simulated impressions, and
if determined that the simulated impression is not frequency capped for the household,
subtracting an amount from the daily budget to simulate an acquisition of the simulated impression for the household,
storing the simulated impression for output to a graphical user interface (GUI), and
performing (b)-(d) for a further simulated impression in the group of simulated impressions.

3. The computer-implemented method of claim 2, further comprising:
if determined that the reach simulation has no available days such that it is not active, generating the output, wherein the output comprises:
stored simulated impressions,
simulated household reach data, and
simulated daily budget spend data.

4. The computer-implemented method of claim 3, further comprising:
determining an estimated reach based on combining the output with historical reach data, and
outputting the combined output to the GUI for display.

5. The computer-implemented method of claim 2, further comprising:
if determined that the simulated impression is not available to be shown to users, performing (a)-(d) for a next available day of the reach simulation.

6. The computer-implemented method of claim 2, further comprising:
if determined that there is not enough daily budget to simulate the bid response for the simulated impression:
estimating the daily budget remaining for the reach simulation, and
performing (a)-(d) for a next available day of the reach simulation.

7. The computer-implemented method of claim 2, further comprising:
performing (a)-(d) for one or more percentages of the daily budget.

8. A non-transitory computer-readable medium having instructions stored thereon that, when executed by at least one computing device, cause the at least one computing device to perform operations comprising:
selecting, by at least one processor of a computing system, a sample of historic content data for a number of households by randomly sampling the historic content data, where the historic content data includes bid requests for available time slots in a multimedia network, bid responses made in response to one or more of the bid requests for outputting supplemental media content in the available time slots, and an indication for each of the bid responses whether the respective bid response was won;
selecting a sample of bid response data from the historic content data by randomly sampling the historic content data, wherein the bid response data includes one or more of the bid responses together with an indication for each bid response of the one or more bid responses whether the respective bid response was won;
determining an estimated win rate by dividing a number of the bid responses won in the sample of bid response data by a total number of the bid responses in the sample of the bid response data;
performing, for each bid request of each household of the number of households in the sample from the historic content data, a Monte Carlo simulation using the estimated win rate, thereby outputting a corresponding prediction whether the respective bid request would be won;
generating, for each prediction output by the Monte Carlo simulation indicating a respective bid request would be won, a simulated impression of the supplemental media content;
aggregating each simulated impression into a group of simulated impressions; and
performing a reach simulation using the group of simulated impressions to determine a reach for distributing the supplemental media content.

9. The non-transitory computer readable medium of claim 8, wherein the operations further comprise:
determining a daily budget for the reach simulation; and
for each simulated impression in the group of simulated impressions,
(a) determining whether the reach simulation has any available days to perform the reach simulation such that the reach simulation is active,
(b) if determined that the reach simulation is active, for an available day of the reach simulation, determining whether the simulated impression is available to be shown to a household,
(c) if determined that the simulated impression is available to be shown to the household, determining whether there is an available daily budget for the available day to simulate a bid response for the simulated impression, and
(d) if determined that there is an available daily budget to simulate the bid response for the simulated impression, determining, for the household, whether the simulated impression is frequency capped for the household for the available day, and
if determined that the simulated impression of the supplemental media content is frequency capped for the household, performing (b)-(d) for a further simulated impression in the group of simulated impressions, and
if determined that the simulated impression is not frequency capped for the household,
subtracting an amount from the daily budget to simulate an acquisition of the simulated impression for the household,
storing the simulated impression for output to a graphical user interface (GUI), and
performing (b)-(d) for a further simulated impression in the group of simulated impressions.

10. The non-transitory computer readable medium of claim 9, wherein the operations further comprise:
if determined that the reach simulation has no available days such that it is not active, generating the output, wherein the output comprises:
stored simulated impressions,
simulated household reach data, and
simulated daily budget spend data.

11. The non-transitory computer readable medium of claim 10, wherein the operations further comprise:
determining an estimated reach based on combining the output with historical reach data, and outputting the combined output to the GUI for display.

12. The non-transitory computer readable medium of claim 9, wherein the operations further comprise:
if determined that the simulated impression is not available to be shown to users, performing (a)-(d) for a next available day of the reach simulation.

13. The non-transitory computer readable medium of claim 9, wherein the operations further comprise:
if determined that there is not enough daily budget to simulate the bid response for the simulated impression:
estimating the daily budget remaining for the reach simulation, and
performing (a)-(d) for a next available day of the reach simulation.

14. The non-transitory computer readable medium of claim 9, wherein the operations further comprise:
performing (a)-(d) for one or more percentages of the daily budget.

15. A system, comprising:
one or more memories; and
at least one processor each coupled to at least one of the memories and configured to perform operations comprising:
selecting a sample of historic content data for a number of households by randomly sampling the historic content data, where the historic content data includes bid requests for available time slots in a multimedia network, bid responses made in response to one or more of the bid requests for outputting supplemental media content in the available time slots, and an indication for each of the bid responses whether the respective bid response was won:
selecting a sample of bid response data from the historic content data by randomly sampling the historic content data, wherein the bid response data includes one or more of the bid responses together with an indication for each bid response of the one or more bid responses whether the respective bid response was won;
determining an estimated win rate by dividing a number of the bid responses won in the sample of bid response data by a total number of the bid responses in the sample of the bid response data;
performing, for each bid request of each household of the number of households in the sample from the historic content data, a Monte Carlo simulation using the estimated win rate, thereby outputting a corresponding prediction whether the respective bid request would be won;
generating, for each prediction output by the Monte Carlo simulation indicating a respective bid request would be won, a simulated impression of the supplemental media content;
aggregating each simulated impression into a group of simulated impressions; and
performing a reach simulation using the group of simulated impressions to determine a reach for distributing the supplemental media content.

16. The system of claim 15, wherein the operations further comprise:
determining a daily budget for the reach simulation; and
for each simulated impression in the group of simulated impressions,
(a) determining whether the reach simulation has any available days to perform the reach simulation such that the reach simulation is active,
(b) if determined that the reach simulation is active, for an available day of the reach simulation, determining whether the simulated impression is available to be shown to a household,
(c) if determined that the simulated impression is available to be shown to the household, determining whether there is an available daily budget for the available day to simulate a bid response for the simulated impression, and
(d) if determined that there is an available daily budget to simulate the bid response for the simulated impression, determining, for the household, whether the simulated impression is frequency capped for the household for the available day, and
if determined that the simulated impression of the supplemental media content is frequency capped for the household, performing (b)-(d) for a further simulated impression in the group of simulated impressions, and
if determined that the simulated impression is not frequency capped for the household,
subtracting an amount from the daily budget to simulate an acquisition of the simulated impression for the household,
storing the simulated impression for output to a graphical user interface (GUI), and
performing (b)-(d) for a further simulated impression in the group of simulated impressions.

17. The system of claim 16, wherein the operations further comprise:
if determined that the reach simulation has no available days such that it is not active, generating the output, wherein the output comprises:
stored simulated impressions,
simulated household reach data, and
simulated daily budget spend data.

18. The system of claim 17, wherein the operations further comprise:
determining an estimated reach based on combining the output with historical reach data, and outputting the combined output to the GUI for display.

19. The system of claim 16, wherein the operations further comprise:
if determined that the simulated impression is not available to be shown to users, performing (a)-(d) for a next available day of the reach simulation.

20. The system of claim 16, wherein the operations further comprise:
if determined that there is not enough daily budget to simulate the bid response for the simulated impression:
estimating the daily budget remaining for the reach simulation;
performing (a)-(d) for a next available day of the reach simulation; and
performing (a)-(d) for one or more percentages of the daily budget.
